(19) United States
(12) Patent Application Publication
(10) Pub. No.: US 2006/0202000 A1
(43) Pub. Date: Sep. 14, 2006

(54) Eccentric rotation soldering method and apparatus

(76) Inventor: Hul-Chun Hsu, Taichung City (TW)

Correspondence Address: HDSL, 4331 STEVENS BATTLE LANE, FAIRFAX, VA, 22033, US

(21) Appl. No.: 11/075,695

(22) Filed: Mar. 10, 2005

(51) Int. Cl. B23K 1/00

(52) U.S. Cl. 228/245; 228/43; 228/48

(57) ABSTRACT

An eccentric rotation soldering method and apparatus, forming a curved sealing portion at one end of a heating after the heat pipe is pressed sealed, and aligning the electrode of a soldering unit with the pressed edge of the sealing portion of the heat pipe. When the heat pipe is rotating, the electrode of the soldering unit is not aligned with the central axis of the heat pipe, such that an eccentric rotation soldering is performed on the pressed edge. Therefore, a rotation soldering trace is formed at the pressed edge to improve the aesthetic effect and integrality of the sealing portion.

### BACKGROUND OF THE INVENTION

The present invention relates in general to an eccentric-rotation soldering method and apparatus, and more particularly, to a method and an apparatus soldering a heat pipe using eccentric rotation between the soldering electrode and the pressed sealed heat pipe, so as to improve the aesthetic effect and integrality of the heat pipe after soldering.

In the fabrication process of a heat pipe, the electrode of a solder gun is typically aligned with the shrunk portion or the center of a pressed sealing portion of the heat pipe in a soldering process performed on a press-sealed portion of the heat pipe for gas removal.

When the electrode of the solder gun is aligned with the center of the heat pipe to perform soldering, electric arc is often generated at the sealing portion of the heat pipe, which results a huge lump of crater. As a result, the soldering crater becomes non-uniform, and the soldering of the press-sealing portion is incomplete.

Another way to perform the soldering process includes inputting a software program into a computer, and controlling the movement of mechanical arm by the computer, so as to displace the electrode of the solder gun along the profile of the sealing portion to perform soldering process on the sealed portion. The soldering process controlled by the mechanical arm often creates a huge lump of puddle crater, or the puddle crater recessed from the center of the press-sealed portion. Thereby, defect heat pipes are resulted after the soldering process. As the soldering crater is unstable, a longer press portion is required along the axis. The unstable length of sealing portion causes disadvantages for forming heat pipes.

### SUMMARY OF THE INVENTION

A soldering process is performed on a press-sealed portion of a heat pipe which is rotated eccentrically, such that the integrality and aesthetic effect of the soldering metal are improved, and the yield of the heat pipe can be enhanced.

The method and apparatus for soldering the electrically rotating heat pipe comprises holding a heat pipe over a driving unit. One end of the heat pipe has been pressed sealed, and the cross section of the sealing portion has an arc shape. Being driven by the driving unit, the soldering electrode is not aligned with the center of the heat pipe. Instead, a relative eccentric rotation is performed between the center of the heat pipe and the soldering electrode. The soldering electrode then performs heat soldering on the sealing portion of the heat pipe. As the heat pipe is rotating during the soldering process, the sealing portion is soldered continuously and repeatedly. Preferably, the soldering current is kept low to maintain uniform soldering part at the soldering metal of the heat pipe. Thereby, the integrality of the soldering metal at the sealing portion of the heat pipe is improved without using expensive mechanical arm.

### BRIEF DESCRIPTION OF THE DRAWINGS

The present invention will become more fully understood from the detailed description given hereinbelow illustration only, and thus are not limitative of the present invention, and wherein:

FIG. 1 is a schematic drawing showing the eccentric rotation soldering process performed on a heat pipe;

FIGS. 2-5 shows the process of the eccentric rotation soldering process; and

FIG. 6 shows the exterior feature of the soldered heat pipe.

### DETAILED DESCRIPTION OF THE INVENTION

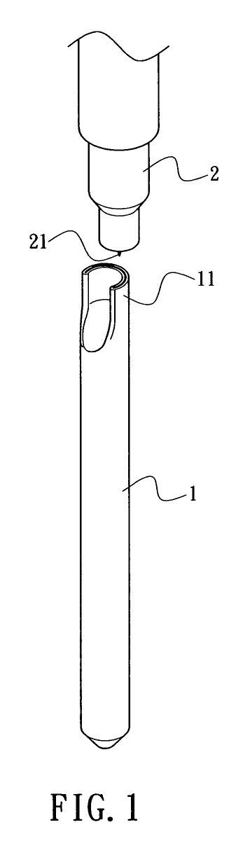

Referring to FIG. 1, the eccentric rotation soldering process of a heat pipe includes press sealing one end of a heat pipe 1, so as to form an arc sealing portion 11 at one end of the heat pipe 1. The press-sealed portion is disposed over a driving unit (not shown) for driving the heat pipe 1 to rotate eccentrically. The soldering unit 2 has an electrode 21 aligned with the edge of the press-sealed portion. Therefore, when the heat pipe 1 is rotating, the soldering electrode 21 is not aligned with the center of the heat pipe 1. Instead, the soldering electrode 21 is aligned with the rotation locus of the edge of the sealing portion.

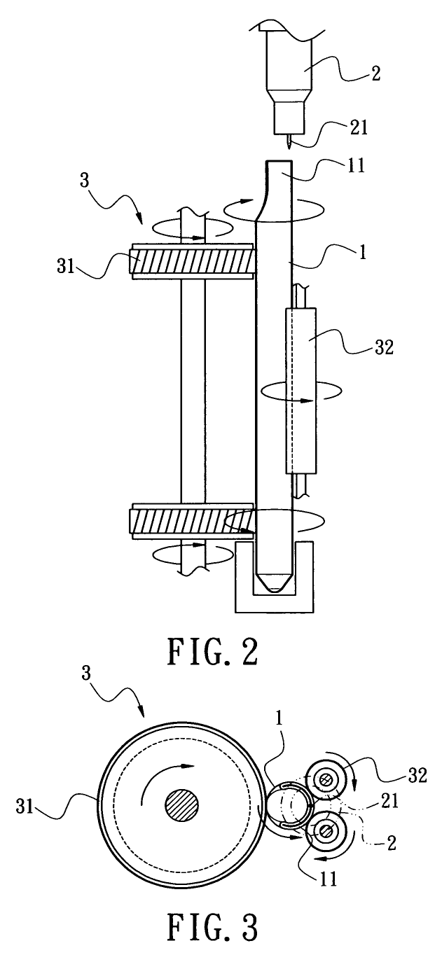

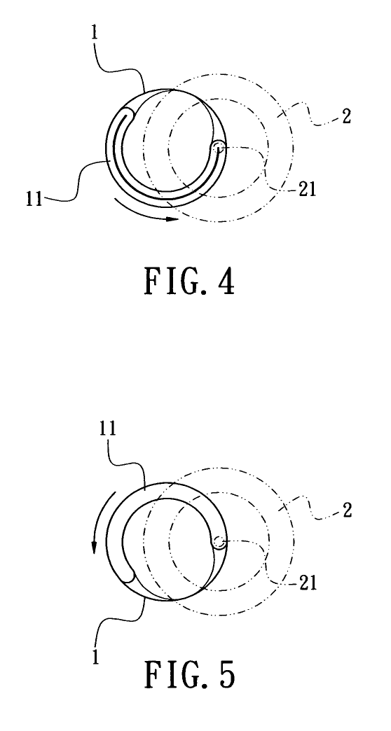

Referring to FIGS. 2-5, before the heat pipe 1 is rotating, a press mechanism presses one end of the heat pipe 1 into a sealing portion 11 having an arc-shaped cross section allowing the eccentric rotation soldering process performed on the heat pipe 1.

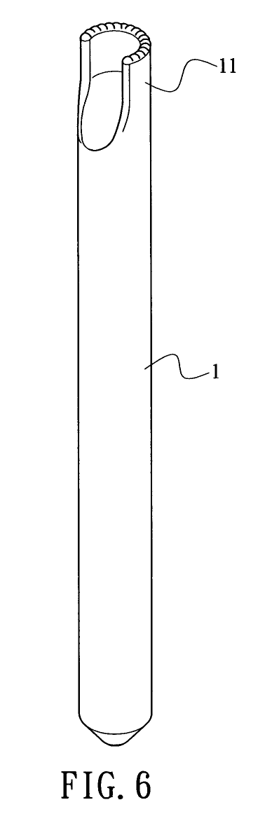

When the heat pipe 1 is press-sealed, the heat pipe is held between the active device 31 and the passive device 32 of the driving unit 1. When the active device 31 is driven by an external control unit (not shown), the heat pipe 1 is synchronously rotating with the active device 31. The passive device 32 is also driven by the heat pipe 1 to rotate. The sealing portion 11 of the heat pipe 1 has an edge eccentrically rotating with respect to the electrode 21 of the soldering unit 2 during the soldering process. By rotating the heat pipe, the soldering electrode 21 induces arc sequentially on the rotation locus of the sealing edge and performs soldering on the sealing portion continuously and repeatedly. Thereby, the soldered channel of the sealing portion 11 of the heat pipe 1 becomes more integral (FIG. 6).

The device used for eccentric rotation soldering process of the heat pipe 1 includes a driving unit 3 and a soldering unit 2.

The driving unit 3 includes an active device 31 for rotating the heat pipe 1 and a passive device 32 rotating with the heat pipe 1. The active device 31 and the passive device 32 include pulley, roller, shaft or platen, for example.

The soldering unit 2 includes an electrode 21 located eccentrically with respect to the sealing edge of the heat pipe 1. Therefore, when the heat pipe 1 is driven to rotate, the electrode 21 of the soldering unit 2 and the sealing edge of the heat pipe 1 are eccentrically rotating with respect to each other.

The driving unit 3 may further include an electric tool clip or pneumatic clip.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An eccentric rotation soldering method for a heat pipe, comprising:
providing a heat pipe having a sealing portion that has an arc-shaped cross section;
holding the heat pipe by a driving unit; and
aligning an electrode of a soldering unit with a sealing edge of the sealing portion of the heat pipe, and driving the heat pipe to rotate eccentrically with respect to the electrode to perform soldering.

2. The method of claim 1, wherein the driving unit comprises an active device and a passive device.

3. The method of claim 1, wherein the active device includes a pulley, roller, shaft or platen.

4. The method of claim 1, wherein the passive device includes a pulley, roller, shaft or platen.

5. The method of claim 1, wherein the driving unit includes an electric-tool clip or a pneumatic clip.

6. An eccentric rotation soldering device for a heat pipe, comprising:
a driving unit for rotating the heat pipe to rotate; and
a soldering unit having an electrode, the soldering device being misaligned with a rotation center of the heat pipe.

7. The device of claim 6, wherein the driving unit comprises an active device and a passive device.

8. The device of claim 7, wherein the active device includes a pulley, roller, shaft or platen.

9. The device of claim 7, wherein the passive device includes a pulley, roller, shaft or platen.

10. The device of claim 7, the driving unit includes an electric-tool clip or a pneumatic clip.
